(19) United States
(12) Patent Application Publication
(10) Pub. No.: US 2011/0170923 A1
(43) Pub. Date: Jul. 14, 2011

(54) EJECTION MECHANISM AND IMAGE FORMING DEVICE

(75) Inventor: Masahiro Haruyama, Tokyo (JP)

(73) Assignee: Oki Data Corporation, Tokyo (JP)

(21) Appl. No.: 12/985,716

(22) Filed: Jan. 6, 2011

(30) Foreign Application Priority Data
Jan. 14, 2010 (JP) 2010-005973

(51) Int. Cl. G03G 15/00; B65H 31/02

(52) U.S. Cl. 399/405; 271/207

(57) ABSTRACT

An ejection mechanism includes: a pair of ejection rollers that upwardly eject at an oblique angle a recording medium carried along a predefined carry path; and an ejection tray that includes a piling surface on which the recording medium ejected from the pair of ejection rollers is piled and a side wall surface that faces a trailing edge of the recording medium piled on the piling surface, wherein, the side wall surface is positioned on an ejection direction upstream side with respect to a plumb line that contacts the pair of the ejection rollers on a ejection direction downstream side, and is formed inclining toward a point separated from the plumb line as the side wall surface travels downward from a bottom part of the pair of the ejection rollers.

### CROSS REFERENCE TO RELATED APPLICATION

The present application is related to, claims priority from, and incorporates by reference Japanese patent application No. 2010-005973, filed on Jan. 14, 2010.

### TECHNICAL FIELD

The present invention relates to a sheet ejection mechanism used for an image forming device, such as a photocopier, a printer, a facsimile, etc.

### BACKGROUND OF THE INVENTION

Conventionally, there is a device that transfers a developer image to a recording medium, that fuses the transferred developer image onto the recording medium, that then ejects the recording medium onto which the developer image is fused to the outside of the device with an ejection roller pair (a pair of ejection rollers), and that stacks the recording medium in a stacker mounted outside of the device. (For example, see JP Laid-Open Patent Publication 2001-175043 (page. 3, FIG. 1.)

However, a conventional ejection mechanism has the possibility of a stacking failure. For example, it may occur, during ejection, that a leading edge part of a recording medium curving downward is caught by a piling surface of a stacker; that a trailing edge part of the recording medium contacting a side surface of the stacker does not smoothly fall down; and that the recording medium is stacked in an ejection tray such that some parts of the recording medium are raised up or jammed when both edges of the ejected recording medium upwardly curve in a direction parallel to an ejection direction. This is highly likely to decrease a stackable amount, resulting in a high possibility that a recording medium, which is successively ejected, pushes a previously ejected recording medium and that the previously ejected recording medium falls out of the ejection tray.

### SUMMARY

An ejection mechanism is provided includes: a pair of ejection rollers that upward eject at an oblique angle a recording medium carried along a predefined carry path; and an ejection tray that includes a piling surface on which the recording medium ejected from the pair of ejection rollers is piled and a side wall surface that faces a trailing edge of the recording medium piled on the piling surface, wherein, the side wall surface is positioned on an ejection direction upstream side with respect to a plumb line that contacts the pair of the ejection rollers on a ejection direction downstream side, and is formed inclining toward a point separated from the plumb line as the side wall surface travels downward from a bottom part of the pair of the ejection rollers.

According to disclosed embodiments, which will be described in the present disclosure, a stackability (or ability to stack sheets) of the ejection tray increases. For example, according to the disclosed embodiments, a possibility is small that the currently ejected recording medium messes the piled recording media, which have already been ejected from the ejection rollers into the ejection tray. Also the possibility of a staking failure caused by a folded or curled recording media is small.

### BRIEF DESCRIPTION OF DRAWINGS

FIG. 1 is a schematic structural view illustrating a main part configuration of an image forming device of a first embodiment.

FIG. 2 is a block diagram illustrating the main part configuration of a control system that controls movements in the image forming device of the first embodiment.

FIG. 3A is a partial sectional view illustrating an enlarged vicinity of ejection rollers and an ejection tray of the ejection mechanism of the first embodiment.

FIG. 3B is a view showing an angle illustrated in FIG. 3A.

FIG. 4 is an appearance perspective view of a vicinity of the ejection tray of the first embodiment, seen from an oblique upper part.

FIG. 5 is a movement explanatory view illustrating movements of the ejection mechanism of the first embodiment.

FIG. 6 is a movement explanatory view illustrating the movements of which the ejection mechanism of the first embodiment processes a print sheet that tends to curl.

FIG. 7 is an appearance perspective view of the vicinity of the ejection tray at which the ejection mechanism of the first embodiment processes the print sheet that tends to curl, seen from the oblique upper part.

FIG. 8 is a view illustrating a configuration and movements of a comparative example.

FIG. 9 is a view illustrating the configuration and the movements of the comparative example.

FIG. 10 is a view illustrating the configuration and the movements of the comparative example.

FIG. 11A is a partial sectional view of an enlarged vicinity of ejection rollers and an ejection tray of an ejection mechanism of a second embodiment. FIG. 11B is a view showing an angle illustrated in FIG. 11A.

FIG. 12 is an appearance perspective view of a vicinity of the ejection tray of the second embodiment, seen from the oblique upper part.

FIG. 13 is a movement explanatory view illustrating movements of the ejection mechanism of the second embodiment.

FIG. 14 is an appearance perspective view of a state of the vicinity of the ejection tray corresponding to FIG. 13, seen from the oblique upper part.

FIG. 15 is an appearance perspective view of an ejection guide member of the second embodiment, seen from a side that forms a carry path.

FIG. 16 is an appearance perspective view of the ejection guide member of the second embodiment, seen from an ejection tray side.

FIG. 17 is a partial sectional view of an enlarged vicinity of ejection rollers and an ejection tray of an ejection mechanism of a third embodiment illustrating an internal configuration and movements.

FIG. 18 is a partial sectional view of an enlarged vicinity of the ejection rollers and the ejection tray of the ejection mechanism of the third embodiment illustrating the internal configuration and the movements.

FIG. 19 is a block diagram illustrating a main part configuration of the control system that controls movements relating to the image forming device of the third embodiment.

### DETAILED DESCRIPTION OF THE EMBODIMENTS

### First Embodiment

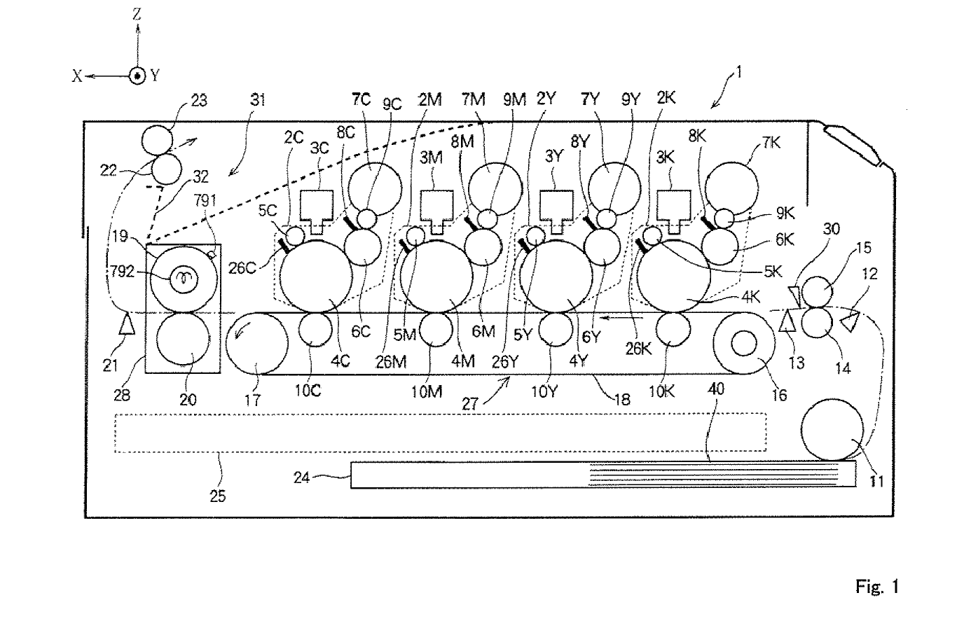

FIG. 1 is a schematic structural view illustrating a main part configuration of an image forming device 1 of a first embodiment including an ejection mechanism.

As illustrated in FIG. 1, the inside of image forming device 1 includes: four large image forming units 2K, 2Y, 2M and 2C; transfer rollers 10K, 10Y, 10M and 10C corresponding to the image forming units; a transfer unit 27 configured with a carry belt 18 that has an endless shape and that carries a recording sheet 40, a belt driven roller 16 and a belt driving roller 17; a sheet cassette 24 that contains a number of the recording sheets 40 and from which the recording sheets are sequentially taken; a feed roller 11 that separately takes the recording sheets 40 one-by-one with a tongue piece for separation from the sheet cassette 24; an entrance sensor 12; a sheet thickness sensor 30; a write sensor 13; carry rollers 14 and 15; a fuse unit 28 configured with a fuse backup roller 20 and a fuse roller 19 that, on the inside, includes a heating element 792 such as a halogen lamp, that heats and pressurizes the recording sheet 40, and that fuses a developer onto the recording sheet 40; ejection rollers 22 and 23 (a pair of ejection rollers) that eject the fused recording sheet 40; and a ejection tray 31 that stacks the recording sheet 40 ejected by the ejection rollers 22 and 23.

The image forming units 2K, 2Y, 2M and 2C are respectively configured to print black, yellow, magenta and cyan with LED heads 3K, 3Y, 3M and 3C, photosensitive drums 4K, 4Y, 4M and 4C, charge rollers 5K, 5Y, 5M and 5C, development rollers 6K, 6Y, 6M and 6C, toner tanks 7K, 7Y, 7M and 7C, development blades 8K, 8Y, 8M and 8C, and toner supply sponge rollers 9K, 9Y, 9M and 9C.

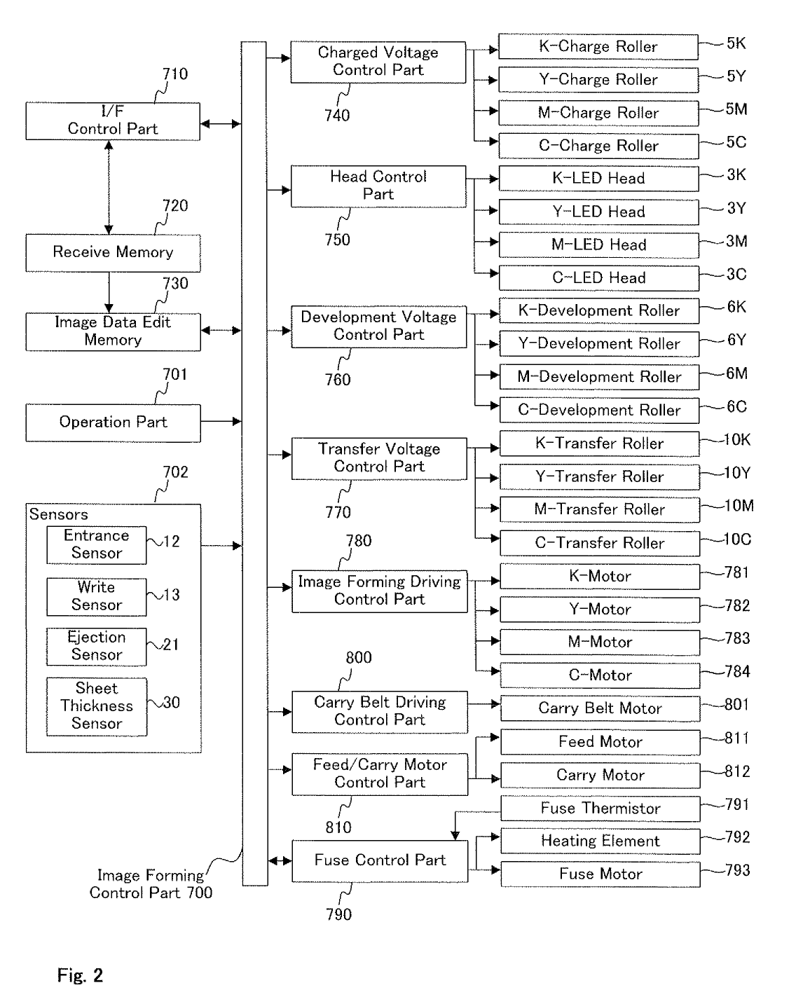

Although not illustrated in FIG. 1, motors for rotating each of the rollers on a carry path disposed at an interval of less than a length of the smallest recording sheet, and a driving force source such as a solenoid, etc. for switching a carry path, etc. are included. As will be described in an explanation of FIG. 2, particularly, the motors are configured with a feed motor 811 for rotating primarily a feed roller 11, a carry motor 812 for rotating carry rollers 14 and 15, a carry belt motor 801 for rotating a belt driving roller 17, a fuse motor 793 for rotating a fuse roller 19, a fuse backup roller 20 and ejection rollers 22 and 23. The image forming units 2K, 2Y, 2M and 2C, respectively, are configured with a K-motor 781, a Y-motor 782, a M-motor 783, and a C-motor 784.

In FIG. 1, an X-axis is in a carry direction in which the recording sheet 40 passes through the image forming units 2K, 2Y, 2M and 2C. A Y-axis is in a rotation shaft direction of the photosensitive drums 4K, 4Y, 4M and 4C, which will be described later. A Z-axis is in a direction orthogonal to both of these axes. When each of the axis-X, axis-Y, and axis-Z is illustrated in other figures, which will be described later, the axis directions indicate the same directions as described above. In other words, the X-axis, Y-axis and Z-axis of each of the figures illustrate arrangement directions for configuring the image forming device 1 illustrated in FIG. 1. Herein, the Z-axis is arranged to be a substantially vertical direction.

FIG. 2 is a block diagram illustrating the main part configuration of a control system that controls movements relating to the image forming device 1.

In FIG. 2, an image forming control part 700 is configured with a microprocessor, a read only memory (ROM), a random access memory (RAM), an input/output (I/F) port, a counter, a timer, etc. The image forming control part 700 receives print data and control commands from a host device, performs a sequence control of a whole printer part, and performs print operation. An I/F control part 710 transmits printer information to the host device, analyzes the commands input from the host device, and processes the data received from the host device. A receive memory 720 stores the data received from the host device for each color based on the control of the I/F control part 710. An operation part 701 includes LEDs for indicating a status of the image forming device 1, and a switch for giving an instruction of the user to the image forming control part 700.

Sensors 702 include a plurality of sensors for detecting a carrying position of the recording sheet 40 (the entrance sensor 12, the write sensor 13, and an ejection sensor 21, etc.), a sheet thickness sensor 30 for detecting a sheet thickness, etc. Outputs from the sensors are input to the image forming control part 700. An image data edit memory 730 edits the print data input from the host device via the I/F control part 710 as image data. In other words, the image data edit memory 730 receives the print data temporarily stored in the receive memory 720 and edits the print data to image data for transmitting to the LED heads 3 (FIG. 1). The image data edit memory 730 stores the edit-processed image data.

A charged voltage control part 740 performs a control, in response to an instruction from the image forming control part 700, for applying voltage to the charge rollers 5 in the image forming units 2 (FIG. 1) and charging a surfaces of the photosensitive drums 4. The charged voltage control part 740 has, in order to control separately for each color, a K-charged voltage control part, a Y-charged voltage control part, a M-charged voltage control part, and a C-charged voltage control part. The charged voltage control parts respectively control applied voltages to the K-charge roller 5K, the Y-charge roller 5Y, the M-charge roller 5M, and the C-charge roller 5C.

A head control part 750 performs a control for exposing the surfaces of the photosensitive drums 4 charged by the LED heads 3 (FIG. 1) by irradiating light in accordance with the image data stored in the image data edit memory 730. The head control part 750 has, in order to control separately for each color, a K-head control part, a Y-head control part, a M-head control part and a C-head control part. The control parts perform a control for respectively transmitting image data at a predetermined timing to the K-LED head 3K, the Y-LED head 3Y, the M-LED head 3M, and the C-LED-head 3C.

In order to adhere toner to an electrostatic latent image generated on the surfaces of the photosensitive drums 4 (FIG. 1) by the LED heads 3, a development voltage control part 760 performs a control for applying voltage to the development rollers 6 in the image forming units 2. For this, the development voltage control part 760 has a K-development voltage control part, a Y-development voltage control part, an M-development voltage control part, and a C-development voltage control part, and the control parts control the applied voltages to the K-development roller 6K, the Y-development roller 6Y, the M-development roller 6M, and the C-development roller 6C.

In order to transfer the toner image generated on the surfaces of the photosensitive drums 4 (FIG. 1) to the recording sheet 40, which is a recording medium, a transfer voltage control part 770 performs a control for applying voltage to transfer rollers 10 (FIG. 1) in response to an instruction of the image forming control part 700. For this, the transfer voltage control part 770 has a K-transfer voltage control part, a Y-transfer voltage control part, an M-transfer voltage control part, and a C-transfer voltage control part. The control parts control the applied voltages respectively to the K-transfer roller 10K, the Y-transfer roller 10Y, the M-transfer roller 10M, and the C-transfer roller 10C, and the toner image generated on the surface of each of the photosensitive drums 4 is sequentially transferred on the recording sheet 40 in a layered manner.

An image forming driving control part 780 performs a control, in response to an instruction from the image forming control part 700, for driving the photosensitive drums 4, the charge rollers 5, and the development rollers 6 included in the image forming units 2 (FIG. 1). For this, the image forming driving control part 780 has a K-ID-motor control part, a Y-ID-motor control part, an M-ID-motor control part, and a C-ID-motor control part. The control parts perform drive controlling of the K-ID motor 781, the Y-ID motor 782, the M-ID motor 783, and the C-ID motor 784 of the respective image forming units.

A fuse control part 790 is a control part for fusing the toner image transferred onto the recording sheet 40. The fuse control part 790 controls a fuse temperature by receiving an instruction from the image forming control part 700 and a detected temperature from a fuse thermistor 791 for measuring the prescribed temperature of the fuse unit 28 (FIG. 1), and by switching on/off a voltage application to a heating element 792 (see FIG. 1) incorporated in the fuse unit 28. When a fuse unit 28 is increased to the predefined temperature, a rotation driving control of the fuse motor 793, which is for rotating the fuse roller 19, the fuse backup roller 20 and the ejection rollers 22 and 23, is performed.

A carry belt motor control part 800 performs, in response to an instruction from the image forming control part 700, a rotation control of the carry belt motor 801 that rotates the belt driving roller 17 that drives the carry belt 18 of the transfer unit 27 (FIG. 1). A feed-carry motor control part 810 performs, in response to an instruction from the image forming control part 700, a rotation driving control of a feed motor 811 that rotates the feed roller 11 that feeds the recording sheet 40, and of a carry motor 812 that rotates the carry rollers 14 and 15 that carry the recording sheet 40.

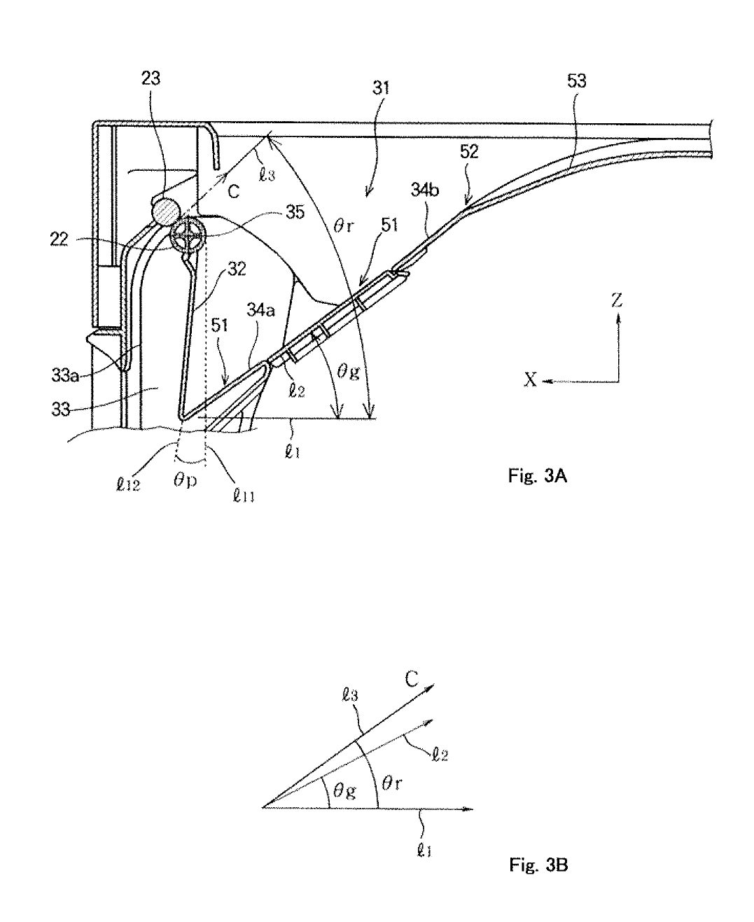

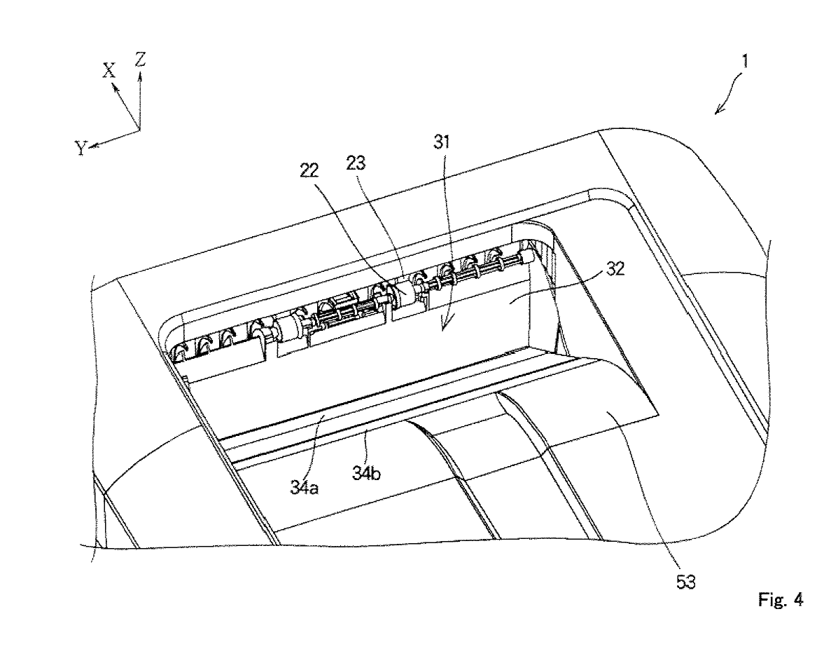

Next, a configuration of the ejection mechanism of the present embodiment will be explained referring to FIGS. 3A, 3B, and 4.

FIG. 3A is a partial sectional view of an enlarged vicinity of the ejection rollers 22 and 23, and the ejection tray 31. FIG. 4 is an appearance perspective view of a vicinity of the ejection tray 31, seen from the oblique upper part. As illustrated in FIG. 3A, the ejection roller 22 is held at a rear edge part of an ejection guide 33a by an ejection guide member 33 that forms the ejection guide 33a that leads the recording sheet 40 (FIG. 1) to the ejection tray 31. The ejection roller 23 is held at a position facing the ejection roller 22 by another part in the device. The rotating ejection rollers 22 and 23 eject the recording sheet 40 being held to the ejection tray 31.

Since an ejection direction where the ejection rollers 22 and 23 eject the recording sheet 40 is a direction where each of rotation shafts of the ejection roller 22 and the ejection roller 23 is perpendicular to a sheet surface (Y-axis direction), the direction is shown by an arrow in the C direction orthogonal to a line connecting each of the shafts. As illustrated in FIG. 3B, the arrow C direction is set to direct obliquely upward, and the angle formed by an imaginary line 1₃ and a horizontal imaginary line 1₁ (X-axis direction) is θr.

The ejection tray 31 that piles the recording sheet 40 ejected by the ejection rollers 22 and 23 in a layered manner is configured with a fixed part 51 formed with the ejection guide member 33, etc., and a movable part 52 formed with a top cover (not illustrated), etc. The fixed part 51 has a side wall surface 32 and an incline surface 34a. The side wall surface 32 is on an ejection direction upstream side (i.e., in a direction along the carry path towards the ejection of the recording sheet 40 by the ejection rollers 22 and 23) with respect to a plumb line 1₁₁ that contacts an ejection direction downstream side (i.e., in a direction along the carry path away from the ejection of the recording sheet 40 by the ejection rollers 22 and 23) of the ejection roller 22. The side wall surface 32 inclines at an angle θp toward a direction extending from the plumb line 1₁₁ and traveling downward from a bottommost part of the ejection roller 22. The incline surface 34a forms an acute angle with the side wall surface 32 and inclines at an angle θg toward a direction extending upward from a horizontal imaginary line 1₁ that contacts a bottom part of the side wall surface 32 extending toward the ejection direction downstream side from the side wall surface 32.

The movable part 52 is configured with a movable incline surface 34b extending along the same plane as the fixed incline surface 34a in a substantially continuous manner (hereafter, this may be referred to as an incline surface 34 when not necessary to distinguish), and a gentle incline surface part 53 extending from the movable incline surface 34b and having an gentle incline. The side wall surface 32, the incline surface 34, and the gentle incline surface part 53 extend in a direction orthogonal to a X-Z plane, and the recording sheet 40 ejected by the ejection rollers 22 and 23 is piled on the incline surface 34.

As illustrated in FIG. 3B, herein, a relationship between θr: an angle formed by the imaginary line 1₁ in a horizontal direction (X-axis direction) and the imaginary line 1₃ in the direction of arrow C (the ejection direction), and θg: an angle formed by the imaginary line 1₁ in the horizontal direction (X-axis direction) and the imaginary line 1₂ extending along the X-Z plane on the incline plane 34 is set to

θg≦θr

wherein, 0°≦θg≦60°, 0°<θr≦90°, preferably, 0°≦θg≦40°, 5°≦θr≦50°. Moreover, θp formed by the plumb line 1₁₁ and the side wall surface 32 is preferably set to

5°≦θp<30°.

Reasons why each range of the angles θg, θr, and θp are set as above are primarily as follows.

1) When the angle θr is larger than 90°, the ejection direction directs in an opposite direction (a plus direction of the X-axis), and an upper limit is preferably set to 50° in order to increase an ejectability to the ejection tray 31, in other words, in order to eject the recording sheet 40 efficiently toward the ejection direction (a minus direction of the X-axis).
2) When the angle θr is larger than 0°, the recording sheet 40 is ejected upward, however, it is preferably set to 5° in order to certainly eject upward.
3) When the angle θg is too large (for example, more than 60°), the recording sheet 40 stacked in the ejection tray 31 tends to riffles. In order to obtain a stable stack in the ejection tray 31, the upper limit is preferably set to 40°.
4) When the angle θg is less than 0°, the recording sheet 40 stacked in the ejection tray 31 moves toward the minus direction of the X-axis, accordingly the angle θg is set to 0° or more.
5) When the angle θp is less than 5°, it becomes difficult to suppress curling of the ejected recording sheet 40 as will be described. When the angle θp is 30° or more, the ejection tray 31 bites into the device inside, it becomes difficult to keep a necessary space, and this increases the size of the device.

Of the above configuration, basic movements of the image forming device 1 relating to the present embodiment will be explained.

The image forming control part 700 illustrated in FIG. 2 receives the control commands and the print data transmitted from the host device via the I/F control part 710, instructs a predefined carry speed to the feed-carry motor control part 810 in response to a receipt of the print instruction from the host device, pulls out one piece of the recording sheet 40 from the sheet cassette 24 by rotating the feed roller 11 illustrated in FIG. 1, and carries it to the carry rollers 14 and 15. The entrance sensor 12 between the feed roller 11 and the carry rollers 14 and 15 is provided to detect whether the feed roller 11 was able to properly feed, and to perform the feed movement again in an error case.

The recording sheet 40 sent to the carry rollers 14 and 15 is carried to the image forming unit 2K by the carry rollers 14 and 15. The image forming units 2K, 2Y, 2M, and 2C start to rotate the rollers almost simultaneously as the feeding starts. At this time, a negative voltage (approximately −1000V) instructed from the image forming control part 700 to the charged voltage control part 740 is applied to the charge rollers 5K, 5Y, 5M and 5C, and the surfaces of the photosensitive drums 4K, 4Y, 4M, and 4C are charged. A toner used for printing is supplied from the toner tanks 7K, 7Y, 7M, and 7C to the development rollers 6K, 6Y, 6M, and 6C via the sponge rollers 9K, 9Y, 9M, and 9C. The toner on the development rollers 6K, 6Y, 6M, and 6C is thinly layered by the development blades 8K, 8Y, 8M, and 8C, and is frictionally charged.

The belt driving roller 17 rotates simultaneously as the photosensitive drums 4K, 4Y, 4M, and 4C start rotating, and moves the carry belt 18 at the same speed as a circumferential speed of each of the photosensitive drums 4. The recording sheet 40 is further carried by the carry rollers 14 and 15, and the write sensor 13 is turned on after the sheet thickness is detected by the sheet thickness sensor 30. The LED head 3K starts to expose when a certain duration passes after detecting a leading edge at this time, and an electrostatic latent image is formed on the photosensitive drum 4K. A toner image according to the electrostatic latent image formed at this time is formed on the photosensitive drum 4K by the development roller 6K. When the recording sheet 40 reaches a point between the photosensitive drum 4K and the transfer roller 10K, a positive voltage (approximately 3000V) is applied to the transfer roller 10K. Then, the toner image on the development roller 10K is drawn toward the recording sheet 40 side and is transferred to recording sheet 40.

The image forming units 2Y, 2M, and 2C for the other colors transfer the toner image of each of the colors in a layered manner, the same as described above. The recording sheet 40 to which the toner image is transferred is heated and pressurized between the fuse roller 19 and the fuse backup roller 20, and the transferred toner image is fused to the recording sheet 40. After being fused, the leading edge of the recording sheet 40 turns on the ejection sensor 21 for monitoring a jam at a heater and for detecting a fused medium length. Then, the recording sheet 40 is ejected in the direction of the above-described arrow C (FIG. 3), which directs the recording sheet 40 upward at an oblique angle, by the ejection rollers 22 and 23, and is piled into the ejection tray 31.

Next, movements of the ejection mechanism of the present embodiment will be described referring to FIGS. 3A-5.

As described above, the recording sheet 40 that is heated and pressurized between the fuse roller 19 and the fuse backup roller 20 is ejected obliquely upward at an angle θr from a horizontal direction by the ejection rollers 22 and 23. When the trailing edge of the recording sheet 40 is passed through the ejection rollers 22 and 23 while being ejected obliquely upward, the recording sheet 40 falls into the ejection tray 31 under its weight from an outer diameter position 35 of the ejection roller 22 on an ejection direction downstream side (a position tangent to the plumb line 1₁₁). As described above, the side wall surface 32 is on the ejection direction upstream side with respect to the plumb line 1₁₁, and is formed inclined at only an angle θp toward a direction where a distance from the plumb line 1₁₁ becomes longer as it travels downward. Therefore, the trailing edge of the falling recording sheet 40 does not contact the side wall surface 32, so that the recording sheet 40 smoothly falls into the ejection tray 31.

As a comparative example, an example in which the ejection direction of the recording sheet 40 by the ejection rollers 22 and 23 is set to a horizontal direction and where the side wall surface 32 inclines toward a reverse direction, will be described.

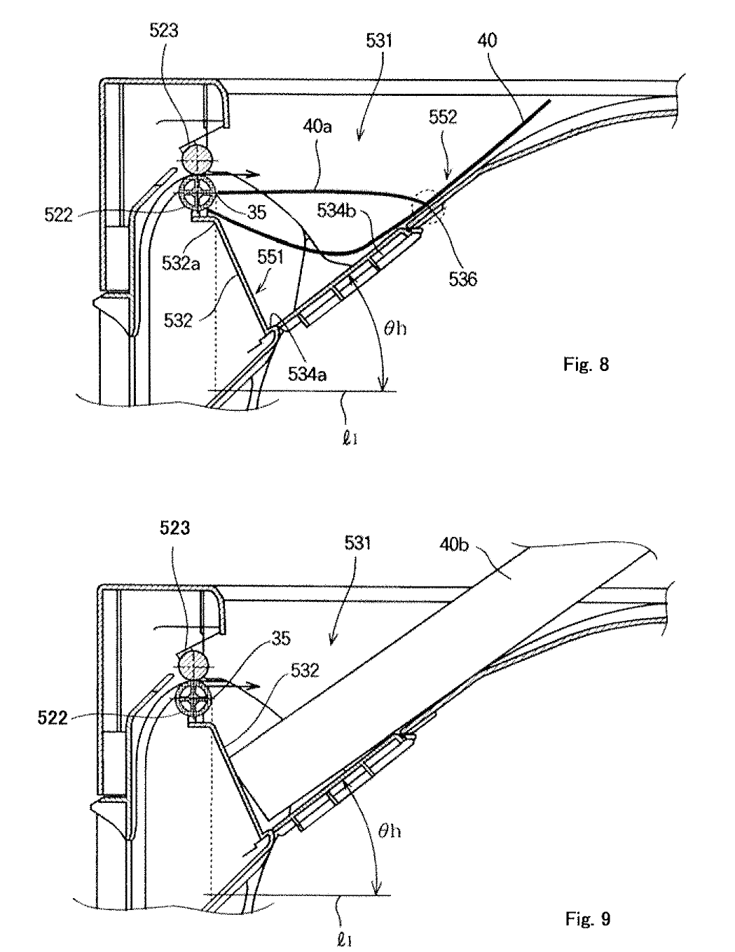

FIG. 8 illustrates a configuration of this comparative example, and is an enlarged cross sectional view illustrating the vicinity of ejection rollers 522 and 523, and an ejection tray 531. Herein, an ejection direction of the recording sheet 40 ejected by the ejection rollers 522 and 523 is set to a horizontal direction, and a side wall surface 532 of a fixed part 551 of the ejection tray 531 is formed downward from the bottom part of the outer diameter position 35 on the ejection direction downstream side of the ejection roller 522 (a position tangent to the plumb line 1₁₁) in the plumb line 1₁₁ direction, or in a direction inclined toward the ejection direction downstream side with respect to the plumb line 1₁₁. Incline surfaces 534a and 534b incline at an angle θh from the horizontal direction in the same direction as the incline surface 34 of the first embodiment.

In this case, as illustrated in FIG. 8, the trailing edge of the recording sheet 40 horizontally ejected by the ejection rollers 522 and 523 passes through the ejection rollers 522 and 523, and then the recording sheet 40 falls into the ejection tray 531 under its weight from the outer diameter position 35 on the ejection direction downstream side of the ejection roller 522. However, since the side wall surface 532 is formed inclined from the bottom part of the ejection roller 522 toward the plumb line 1₁₁ direction or toward the ejection direction downstream side with respect to the plumb line 1₁₁, the trailing edge of the recording sheet 40 may be caught by a starting point 532a of the side wall surface 532 or an incline surface 534a itself, and a stack failure like the recording sheet 40 illustrated in FIG. 8 may be caused.

Next, a functional effect due to which the recording sheet 40 is ejected in the direction of arrow C, which directs obliquely upward, because of an arrangement of the ejection rollers 22 and 23 will be described with respect to the comparative example.

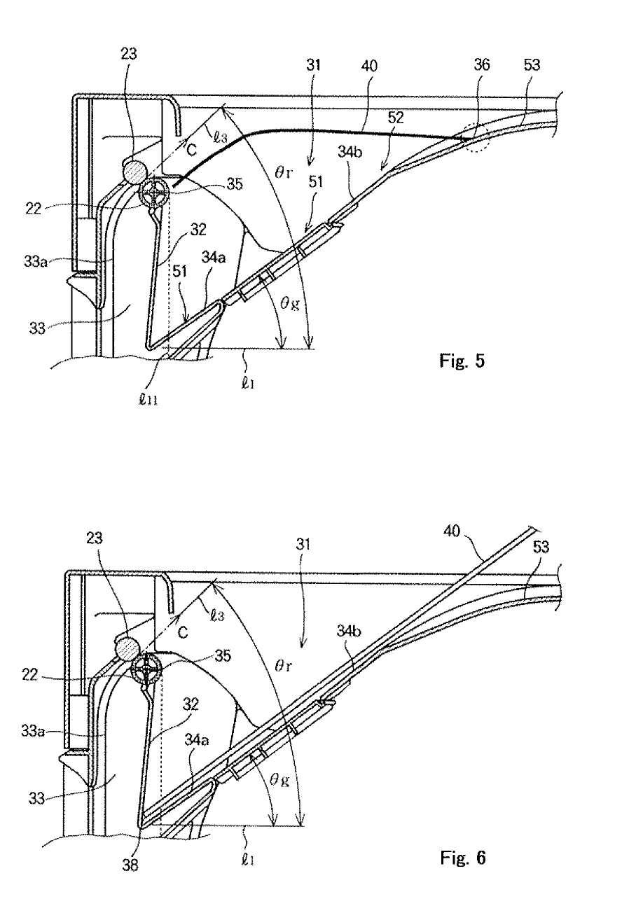

The recording sheet 40 in FIG. 5 and the recording sheet 40a in FIG. 8 illustrate a state example of each case of the present embodiment and the comparative example where the leading edge part hangs under its weight while being ejected by the ejection rollers. As illustrated in FIG. 5, herein, the leading edge of the recording sheet 40a bends down due to its weight before the trailing edge of the recording sheet 40a is ejected. However, since the recording sheet 40a is ejected obliquely upward in the direction of arrow C, the contact position 36 where the leading edge of the recording sheet 40a contacts the ejection tray 31 can be moved toward the ejection direction downstream side with respect to a contact position 536 of the comparative example illustrated in FIG. 8. For this, even when the recording medium 40a falls turning around the contact position 36 as a pivot point, the trailing edge of the recording sheet 40a is less likely to contact the side wall surface 32. Even though the recording sheet 40a contacts the side wall surface 32, the trailing edge part smoothly falls with an assistance of the inclined side wall surface 32 as illustrated above.

Furthermore, in the present embodiment, the relation between θr an angle formed by the ejection direction and the horizontal direction, and θg: an angle formed by the incline surface 34 and the horizontal direction, is set to θg≦θr. Therefore, when the leading edge does not bend down (i.e., remains straight), the recording sheet 40 falls without contacting the leading edge part with the ejection tray 31. And when the leading edge of the recording sheet 40 bends down, the contact position 36 where the leading edge contacts the ejection tray 31 can be further moved toward the ejection direction downstream side rather than the case where θg>θr.

Next, referring to the comparative example, a case will be described where the recording sheet 40 that is heated and pressurized between the fuse roller 19 and the fuse backup roller 20 is a curling recording sheet 40b under a state where both side parts are held parallel to the ejection direction after it is ejected by the ejection rollers 22 and 23.

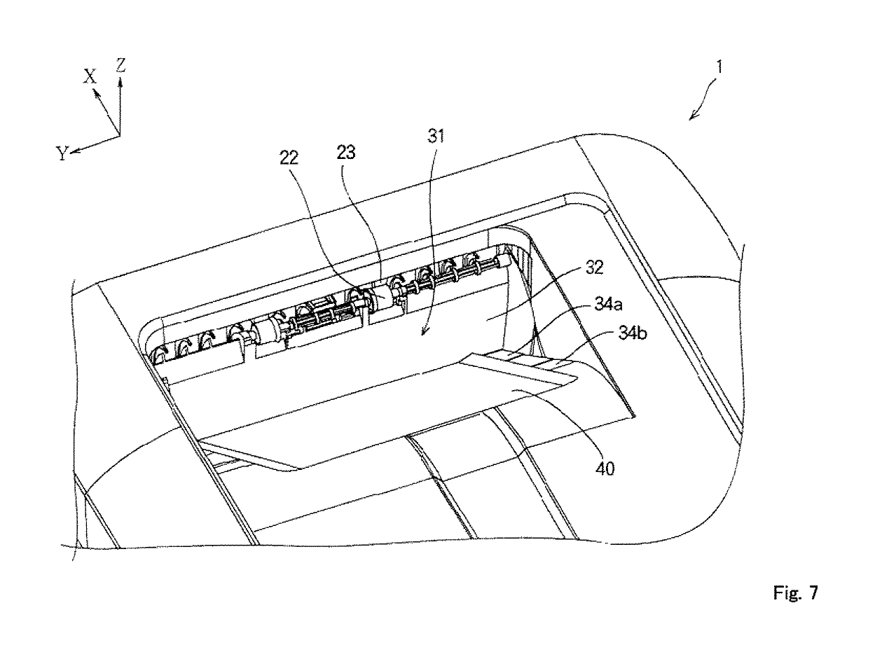

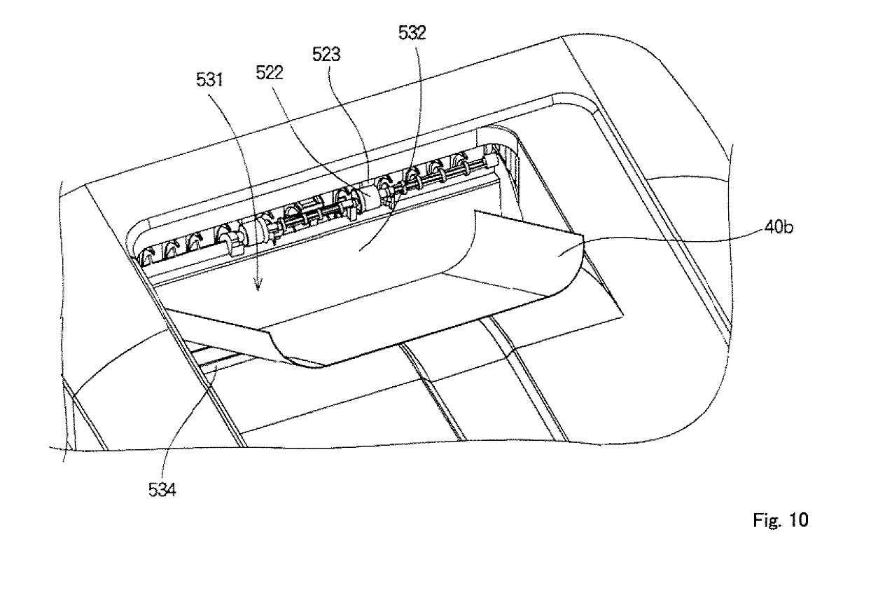

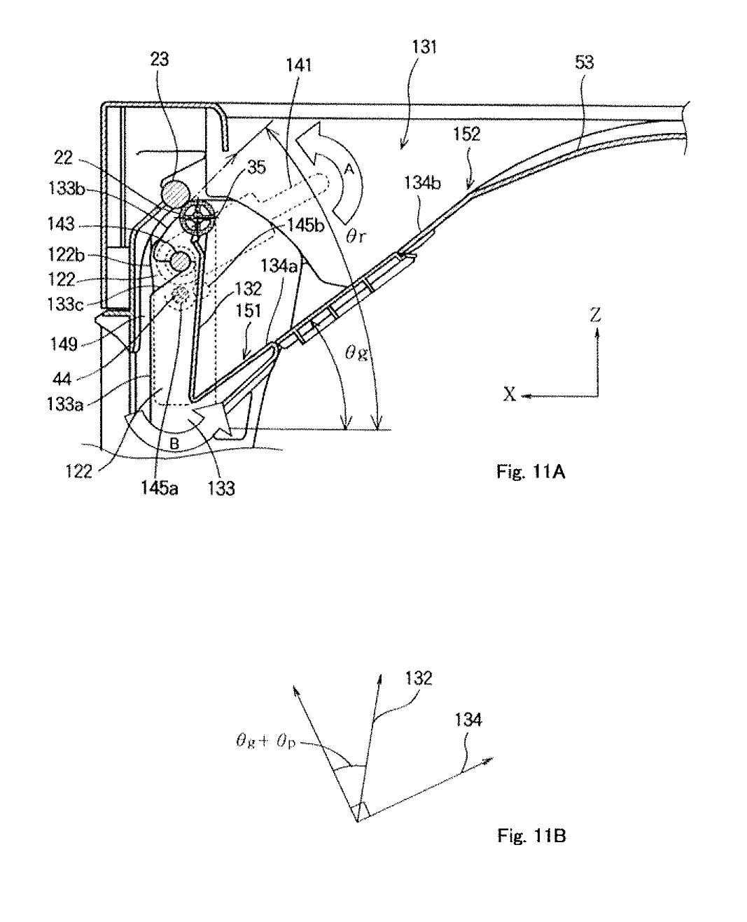

FIG. 6 is a structural view illustrating movements of the ejection mechanism of the present embodiment at this time. FIG. 7 is an appearance perspective view of the ejection tray 31 and the vicinity, seen obliquely from the upper part. FIG. 9 is a structural view illustrating movements of the ejection mechanism of the comparative example at this time. FIG. 10 is an appearance perspective view of the vicinity of the ejection tray 531, seen obliquely from the upper part.

Generally, when the recording sheet is a thin sheet, the recording sheet 40b curls more apparently than a thick sheet. As time passes after heating and pressurizing by the fuse roller 19 and the fuse backup roller 20 (FIG. 1), the curling amount increases. In the case of the comparative example, as illustrated in FIGS. 9 and 10, the recording sheet 40b ejected from the ejection rollers 522 and 523 falls into the ejection tray 531, bumps against the side wall surface 532, and is stacked. Since the side wall surface 532 is inclined downward from the bottom part of the outer diameter position 35 (the position tangent to the plumb line on the ejection direction downstream side of the ejection roller 522 toward the plumb line 1₁₁ direction, or toward the ejection direction downstream side with respect to the plumb line 1₁₁, the trailing edge part of the recording sheet 40b is less likely to receive a force for suppressing the above-described curling, and the recording sheet 40b is deformed (curled) as time passes.

In the case of the ejection mechanism of the present embodiment, as illustrated in FIGS. 6 and 7, the recording sheet 40b ejected from the ejection rollers 22 and 23 falls down into the ejection tray 31, the trailing edge bumps to the side wall surface 32, and the recording sheet 40b is stacked. The trailing edge of the recording sheet 40b fits into the ridge part 38 at which the side wall surface 32 and the incline surface 34 cross at an acute angle, and the deformation (curling) upward is regulated by the side wall surface 32. Therefore, failures can be prevented such as that a stackable amount of the recording sheets is decreased due to the curl of the stacked recording sheets 40 and that the curled recording sheet, which has already been ejected into the ejection tray 31, is pushed out of the ejection tray 31 by a successively ejected recording sheet 40.

As described above, with respect to the ejection mechanism of the present embodiment, the recording sheet 40 that is ejected by the ejection rollers 22 and 23 is piled smoothly on the ejection tray 31 without the trailing edge part being caught by the side wall surface 32 of the ejection tray. It can also suppress curling of both side parts of the piled recording sheet 40. Therefore, it becomes possible to stack the sequentially ejected recording sheet 40 properly on the ejection tray.

### Second Embodiment

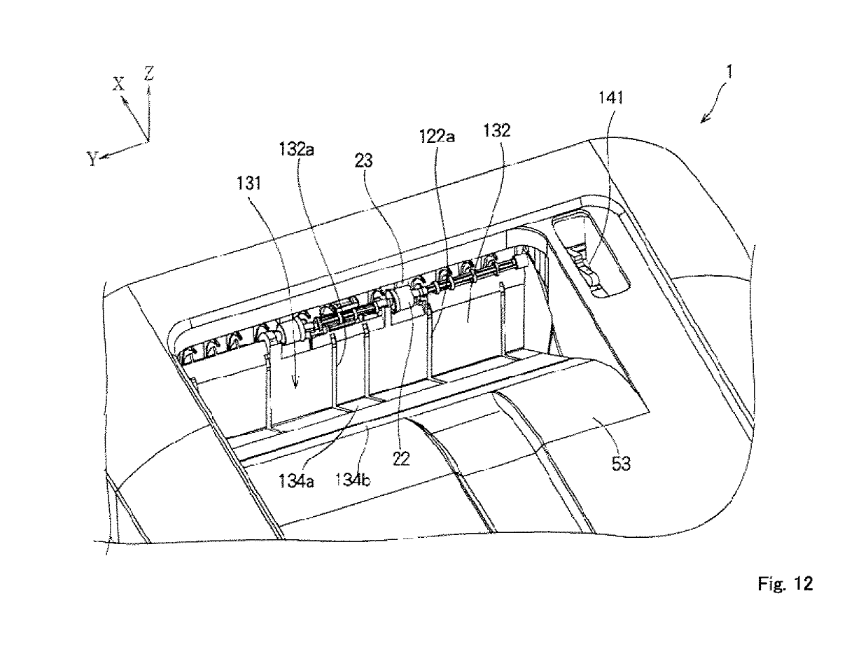

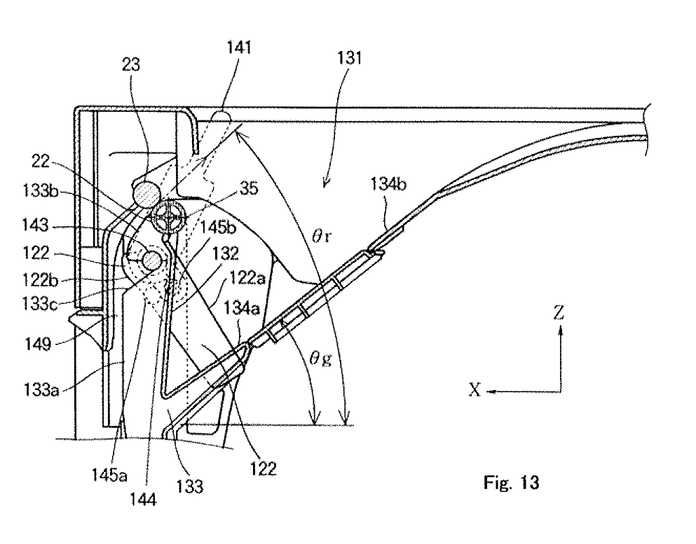

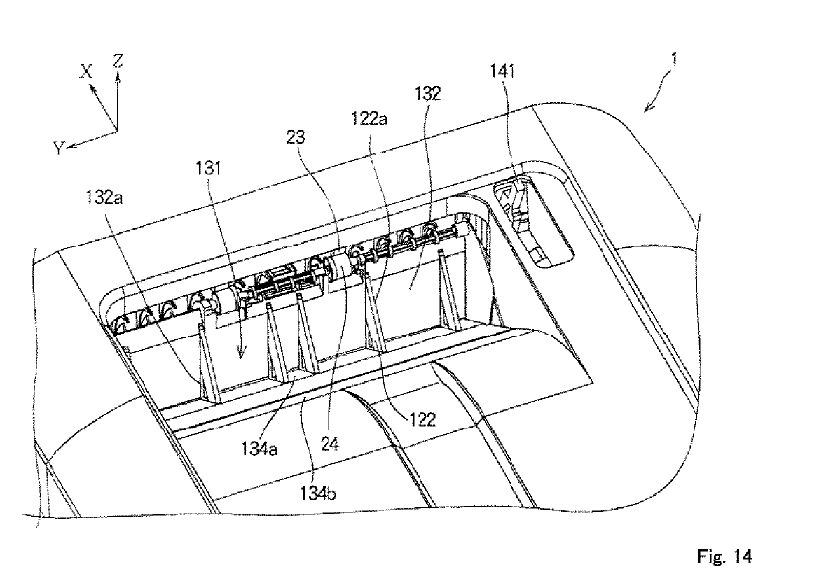

FIG. 11A is a partial cross sectional view of the vicinity of the ejection rollers 22 and 23 and the ejection tray 131 of the ejection mechanism of a second embodiment. FIG. 12 is an appearance perspective view of the vicinity of ejection tray 131, seen obliquely from the upper part. FIG. 13 is a view illustrating movements of an ejection mechanism. FIG. 14 is an appearance perspective view of the vicinity of the ejection tray 131 at this time, seen obliquely from the upper part.

The primary difference between this ejection mechanism and the ejection mechanism of the above-mentioned first embodiment is that trailing edge guide members 122 that are pivotably held to an ejection guide member 133 are added. Therefore, the same numerals are given to corresponding parts of the image forming device, which adopts this ejection mechanism, to the image forming device 1 (FIG. 1) of the above-described first embodiment, and drawings and explanation of the corresponding parts are omitted. Different points will be specifically explained.

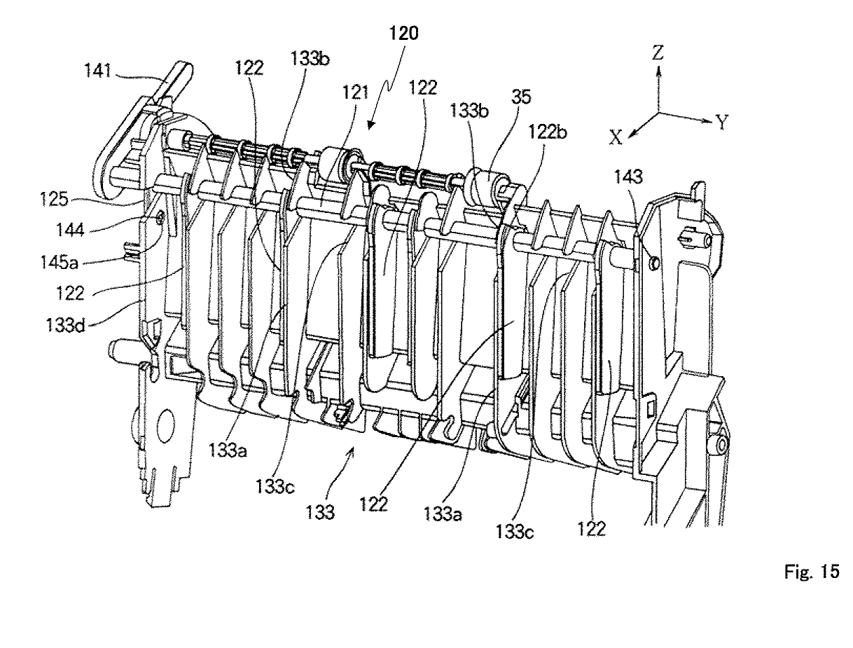

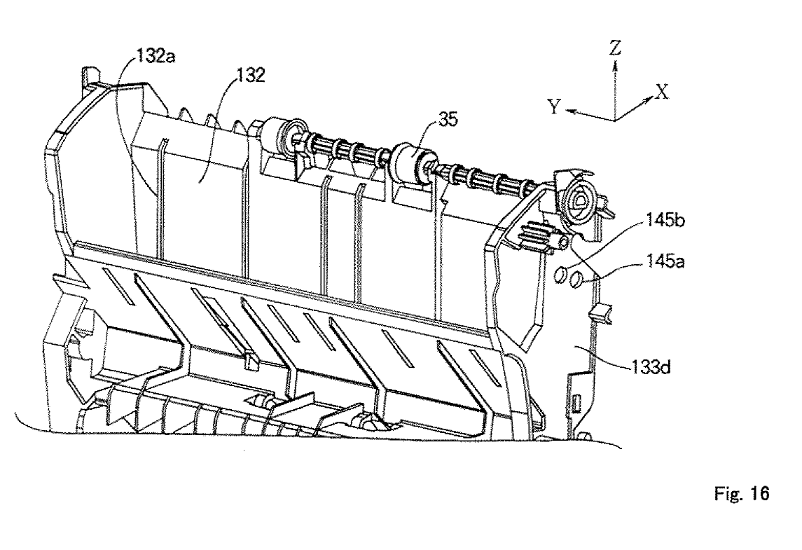

FIG. 15 is an appearance perspective view of the ejection guide member 133 of the present embodiment, seen from a carrying path 149 side (FIG. 11A). Similarly, FIG. 16 is an appearance perspective view of the ejection guide member 133 seen from an ejection tray 131 side (FIG. 11A). As illustrated in FIGS. 11A, 15, and 16, in the ejection guide member 133, a plurality of first ejection guides 133a (12 pieces herein) and the same pieces of second ejection guides 133b (12 pieces herein) are formed. The first ejection guides 133a form the carry path 149 of the recording sheet 40, and are aligned in the Y-axis direction. The second ejection guides 133b are positioned in the carrying direction downstream side with respect to the first ejection guides 133a, and form the carrying path 149. Cut-off parts 133c are formed between each of the first ejection guides 133a and the second ejection guides 133b, and the cut-off parts 133c are rotatably arranged to a pivotal guide member 120.

The pivotal guide member 120 includes a pivotal shaft part 121 and six pieces of the trailing edge guide member 122. The trailing edge guide members 122 are fixed to the pivotal shaft part 121 at multiple parts (herein 6 parts) of the pivotal shaft part 121 in a longitudinal direction (or Y-axis direction). The pivotal guide member 120 is rotatably attached to the ejection guide member 133 by the rotation support member 143 supporting the pivotal shaft part 121. When the user operates a lever 141 attached to one edge part of the pivotal guide member 120, the pivotal guide member 120 pivots between a stand-by position illustrated in FIGS. 11A, 12, 15, and 16, and an operative position illustrated in FIGS. 13 and 14, which will be described below. A hemispherical projection 144 is formed on a holding member 125 (FIG. 15) that is flexible and that rotates integrally with the pivotal shaft part 121. Cylindrical holes 145a and 145b, which engage to the hemispherical projection 144 when the pivotal guide member 120 is at the stand-by position or the operative position, are formed on a side wall part 133d of the ejection guide member 133. Therefore, the pivotal guide member 120 is positionally controlled between the stand-by position and the operative position by a predefined controlling force. The pivotal guide member 120 is a term representing a general component that is formed by the pivotal shaft 121, the trailing edge guide member 122 (122a and 122b) and the holding member 125.

The side wall surface 132, which is a part of the fixed part 151 of the ejection tray 131 is attached to the ejection guide member 133 as illustrated in FIG. 16. Slits 132a are formed at positions (6 parts) of the side wall surface 132 that face the trailing edge guide members 122. When the pivotal guide member 120 is at the operative position, guide parts 122a that are sides of the trailing edge guide members 122 on the ejection tray 131 side protrude to a position where the trailing edge guide members 122 are approximately perpendicular to the incline surface 134 of the ejection tray 131 via the slits 132a as illustrated in FIGS. 13 and 14. When the trailing guide members 122 are at the stand-by position, the guide parts 122a do not protrude from the slits 132a and are stored in a manner of forming an approximately planar with the side wall surface 132 as illustrated in FIGS. 11A, 12, etc. Furthermore, in order that the recording sheet 40 carried through the carrying path 149 is not caught by the cut-off parts 133c, carry guide parts 122b, which are also referred to as a subsidiary guide part, are formed to support the cut-off parts 133c in the view from the Y-axis direction.

As illustrated in FIG. 11A, the carry guide parts 122b are positioned at a slightly stepped-back position from the currying path 149 with respect to the first ejection guides 133a of the ejection guide member 133. The carry guide parts 122b are configured to have a smooth guide surface slightly protruded toward the carrying path 149 with respect to the second ejection guides 133b of the ejection guide member 133. As the result, the recording sheet 40 that is carried under the guide of the first ejection guides 133a smoothly moves to the second ejection guides 133b without getting hooked by the cut-off parts 133c. Furthermore, as illustrated in FIGS. 11A and 13, the carry guide parts 122b are configured not to be changed depending on whether the pivotal guide member 120 is at the stand-by position or the operative position.

Under the above-described configuration, movements of the ejection mechanism of the present embodiment will be described.

As illustrated in FIG. 11A, when the pivotal guide member is at the stand-by position, the guide parts 122a of the trailing edge guide members 122 do not protrude from the slits 132a, and are approximately flush with the side wall surface 132. Therefore, the recording sheet 40 sequentially ejected from the ejection rollers 22 and 23 stacks in the ejection tray 131 in a proper manner as in the case of the ejection mechanism of the above-described first embodiment. At this time, as illustrated in FIG. 11B, the trailing edge of the recording sheet 40 stacked in the ejection tray 131 is stacked along the side wall surface 32 inclined at an angle (θg+θp) from a direction perpendicular to the incline surface 134.

Herein, the user moves the lever 141 in the direction of arrow A, and pivots the pivotal guide member 120 from the stand-by position to the operative position. In accompaniment with this rotation, the projection 144 get detached from the cylindrical hole 145a, and the trailing edge guide members 122 move toward the direction of arrow B via the slits 132a. Then, the projection 144 engages to the cylindrical hole 145b, and the guide parts 122a of the trailing edge guide members 122 are positioned approximately perpendicular to the incline surface 134 of the ejection tray 131, as illustrated in FIGS. 13 and 14. The trailing edge guide members 122 move to align the trailing edge of the recording sheet 40 stacked in the ejection tray 131 approximately perpendicularly to the incline surface 134 with the guide parts 122a. Therefore, an alignability of the edge parts of the recording sheet 40 is increased.

The pivotal guide member 120 is pivotably disposed around the pivotal shaft part 121 (FIG. 15) that is held by the rotation support member 143. Therefore, the user can set the position of the guide parts 122a to the stand-by position or the operative position in advance depending on a type of the recording sheet 40 by operating the lever 141. In general, in the case of a less curling recording sheet such as a bond sheet, the user positions the guide parts 122a to the operative position where the guide parts 122a becomes approximately perpendicular to the incline surface 134 before ejection so that the trailing edge of the recording sheet aligns from the beginning.

As described above, according to the ejection mechanism of the present embodiment, even when the recording sheet sequentially ejected into the ejection tray 131 stacks such that the trailing edge part is placed along the side wall surface 132 formed at an acute angle to the incline surface 134 that is the piling surface, the trailing edge part is aligned approximately perpendicular to the piling surface by the user's simple lever operation. As the result, the alignability of the edge part of the recording sheet in the ejection direction align is increased. Also, when it is judged a failure during stacking is not likely to occur based on the types of the recording sheet, positions of the guide parts 122a can be set to be approximately perpendicular to the piling surface in advance. Therefore, in this case, the quality that the recording sheet aligns in the ejection direction is increased without the user's lever operation.

### Third Embodiment

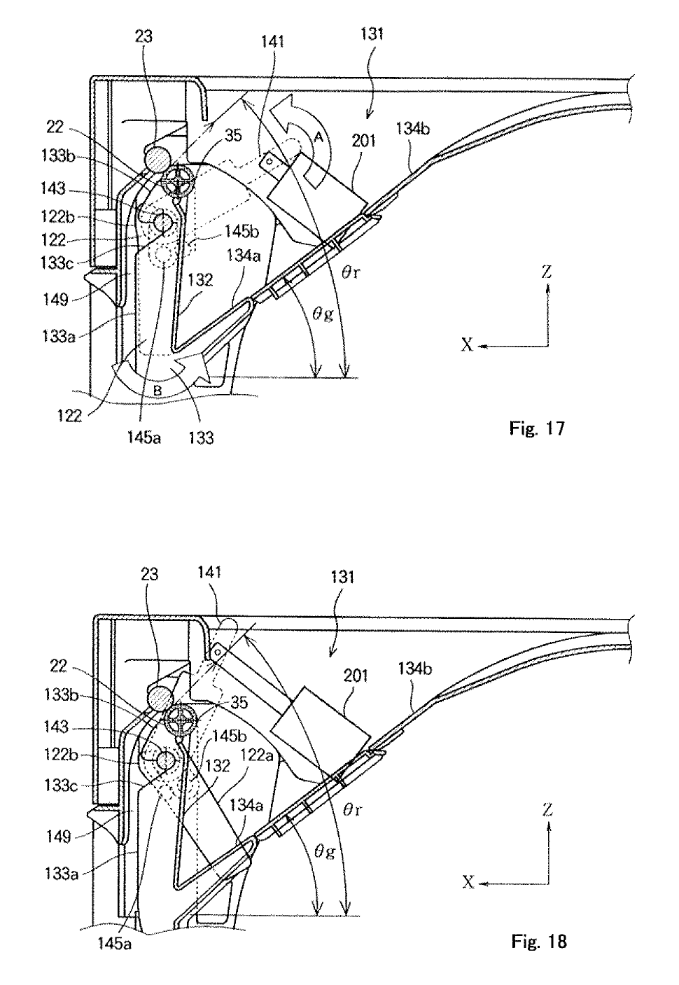

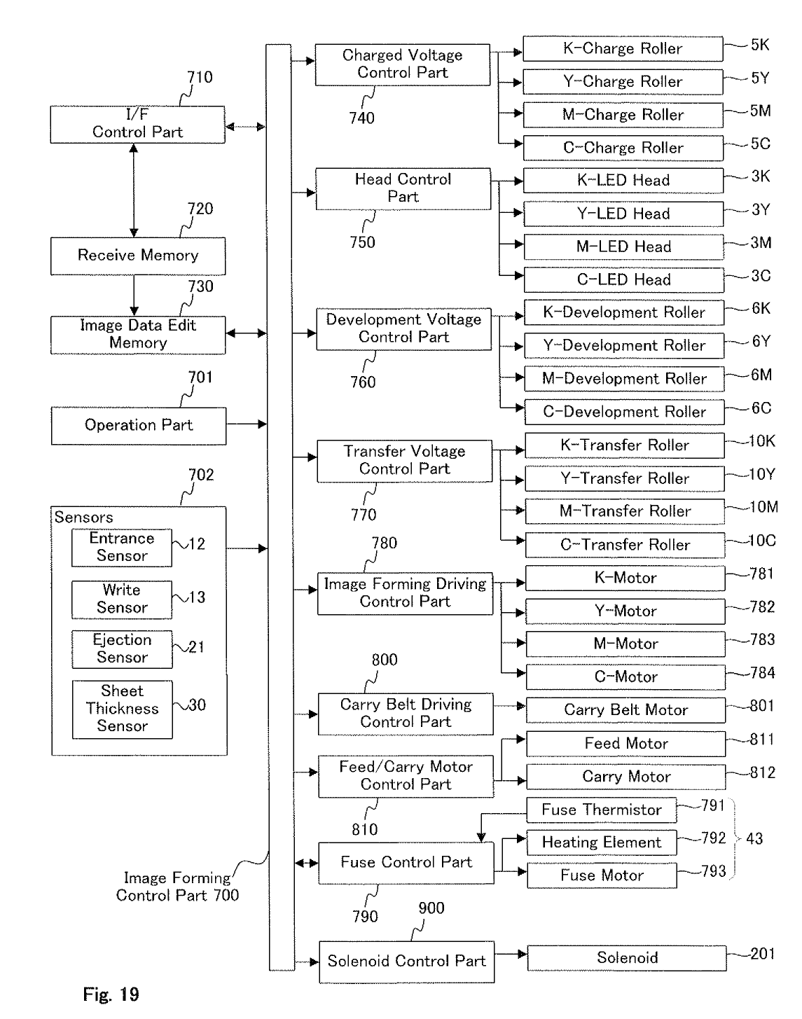

FIGS. 17 and 18 are partial cross sectional view of an enlarged vicinity of the ejection rollers 22 and 23 and the ejection tray 131 of the ejection mechanism of third embodiment illustrating an internal configuration and movements. FIG. 19 is a block diagram illustrating a main part configuration of a control system that controls movements relating to the image forming device 1.

Specific different points between the ejection mechanism of the present embodiment and the ejection mechanism of the above-described second embodiment are a solenoid 201 for pivoting the lever 141, and a control part 900 for drive-control of the solenoid 201. The same numerals are given to parts where the image forming device that adopts this ejection mechanism corresponds to the image forming device 1 (FIG. 1) of the above-described first embodiment and to the ejection mechanism part (FIG. 11) of the second embodiment, and drawings and explanation of the corresponding parts are omitted. Different points will be specifically explained.

The solenoid 201 including an arm linked to the lever 141 is added to the ejection mechanism part of the present embodiment for pivoting the lever 141 as illustrated in FIG. 17. A solenoid control part 900 (FIG. 19) for drive-controlling the solenoid 201 in response to an instruction from the image forming control part 700 is added to the control system as illustrated in FIG. 19. The lever 141 is biased toward the direction of arrow A with a bias member (not illustrated). When the solenoid 201 is off, the pivotal guide member 120 is regulated to be positioned at the operative position as illustrated in FIG. 18. When the solenoid 201 is on, the arm is pulled, the lever 141 is rotated in an direction opposite to the direction of arrow A against the bias force, and the pivotal guide member 120 is regulated to be positioned at the stand-by position as illustrated in FIG. 17.

Under the above-described configuration, movements of the ejection mechanism of the present embodiment will be described.

Fundamental movement of the ejection mechanism part except for that the lever 141 receives pivotal force from the bias member (not illustrated) and the solenoid 201 is the same as the movements of the above-described second embodiment. Herein, the image forming control part 700 drive-controls the solenoid 201 via the solenoid control part 900 depending on received sheet type information of the recording sheet 40, for example, when the image forming control part 700 receives data of the recording sheet 40 from the host device via the I/F control part 710, when the image forming control part 700 receives data of the recording sheet 40 input by the user with the operation part 701, and when the image forming control part 700 receives a sheet thickness data from the sheet thickness sensor 30. The trailing edge guide members 122 rotate by drive-controlling the solenoid 201 as described above, and this allows automatic switching of the position of the guide parts 122a.

For example, when the image forming control part 700 judges that the recording sheet 40 to be printed is a thin sheet according to the information from the sheet thickness sensor 30, the solenoid 201 is switched on via the solenoid control part 900, and the pivotal guide member 120 pivots to the stand-by position illustrated in FIG. 17. When the recording sheet 40 to be printed is judged as a thick sheet, the solenoid 201 is switched off via the solenoid control part 900, and the pivotal guide member 120 is rotated to the operative position illustrated in FIG. 18.

When a series of printing is performed to eject the recording sheet 40 into the ejection tray 131 with the pivotal guide member at the operative position and when the pivotal guide member 120 is configured to pivot to the operative position after printing, the alignability of the edge part in the ejection direction of the recording sheet is increased by itself.

An explanation of movements of a thin recording sheet 40 sequentially stacked from the ejection rollers 22 and 23 into the ejection tray 131 with the pivotal guide member 120 at the stand-by position, and movement of a thick recording sheet 40 sequentially stacked from the ejection rollers 22 and 23 into the ejection tray 131 with the pivotal guide member 120 at the operative position are omitted since they are the same as explained in the first embodiment and the second embodiment.

As described above, with the ejection mechanism of the present embodiment, it is possible to automatically switch the position of the guide parts 122a of the trailing edge guide members 122 due to the installation of the solenoid 201 to the ejection mechanism of the second embodiment. This reduces the trouble of manual switching. Also, the position of the guide parts 122a is automatically switched from the stand-by position to the operative position after the printing, so that this gives an effect that the edge part of the recording sheet ejected into the ejection tray is aligned without troubling the user.

In each of the above-described embodiments, the independent K motor 781, Y motor 782, M motor 783, and C motor 784 are respectively used for driving the image forming units 2K, 2Y, 2M, and 2C. However, it may be not limited to this configuration. Each of these elements may take a configuration where they are driven by one motor, and take various aspects.

Each of the above-described embodiments uses a light-emitting diode (LED) head for the exposure unit of the image forming device. However, in alternate embodiments, a laser exposure unit configured with a small laser and a polygon mirror also are applicable. Similarly, each of the embodiments was explained with the image forming device of direct transfer, however, an image forming device using an intermediate transfer belt is also applicable. Furthermore, each of the above-described embodiments explained the example of the image forming device being a printer, however, it is also applicable for the case of a photocopier, a facsimile machine, etc. Furthermore, the recording sheet is used as a recording medium in the embodiments, however, not only for the recording sheet but also a sheet shaped staff on which a print head can form an image is applicable. The recording medium is, for example, an overhead projector (OHP) sheet, a label, or a cloth, which has extremely thin thickness with respect to a print surface.

What is claimed is:

1. An ejection mechanism, comprising:
a pair of ejection rollers that upward eject at an oblique angle a recording medium carried along a predefined carry path; and
an ejection tray that includes a piling surface on which the recording medium ejected from the pair of ejection rollers is piled and a side wall surface that faces a trailing edge of the recording medium piled on the piling surface, wherein
the side wall surface is positioned on an ejection direction upstream side with respect to a plumb line that contacts the pair of the ejection rollers on a ejection direction downstream side, and is formed inclining toward a point separated from the plumb line as the side wall surface travels downward from a bottom part of the pair of the ejection rollers.

2. The ejection mechanism according to claim 1, wherein
the piling surface is formed such that it inclines upward at an angle θg from a horizontal line that contacts a bottommost part of the side wall surface, and
the piling surface extends on the ejection direction upstream side of the side wall surface.

3. The ejection mechanism according to claim 2, wherein
an angle θr is formed between an ejection direction and the horizontal line, and
wherein θg≦θr.

4. The ejection mechanism according to claim 1, further comprising,
a pivotal guide member that is movably held between a stand-by position in which it does not protrude from the side wall surface and an operative position in which it does protrude from the side wall surface.

5. The ejection mechanism according to claim 4, wherein
the pivotal guide member includes a plurality of trailing edge guide members that are arranged on the pivotal shaft, each trailing edge guide member having a guide part, and a pivotal shaft part on which the plurality of trailing edge guide members are arranged in its shaft direction, and
the ejection mechanism further includes a plurality of ejection guides including:
a first ejection guide,
a second ejection guide positioned on the ejection direction downstream side with respect to the first ejection guide, and
a cut-off part formed between the first ejection guide and the second ejection guide.

6. The ejection mechanism according to claim 5, wherein
the pivotal guide member is formed by inserting the pivotal shaft part in the cut-off part.

7. The ejection mechanism according to claim 6, wherein
the trailing edge guide member includes a subsidiary guide part that supports the cut-off part,
the subsidiary guide part includes a smooth guide surface positioned at a position stepped back from an ejection side of a carry path with respect to the first ejection guide, and
the subsidiary guide part slightly protrudes toward the ejection side of the carry path.

8. The ejection mechanism according to claim 4, wherein
the pivotal guide member includes a plurality of trailing edge guide members, and
the side wall surface includes a plurality of slits formed in correspondence with the trailing edge guide members.

9. The ejection mechanism according to claim 4, wherein
in the stand-by position, the trailing edge guide member is stored in the slit, and
in the operative position, the trailing edge guiding member protrudes from the slit.

10. The ejection mechanism according to claim 4, wherein
the pivotal guide member includes a lever that is integrated to the pivotal shaft part and is configured to receive pivotal force.

11. The ejection mechanism according to claim 4, further comprising
a driving force source configured to pivotally drive the pivotal guide member.

12. An image forming device, comprising the ejection mechanism according to claim 1.

13. An image forming device, comprising;
the ejection mechanism according to claim 11: and
a control part configured to controls the driving force source,
wherein the pivotal guide member in configured to move between the stand-by position and the operative position in response to information input by the control part.
